(19) United States
(12) Patent Application Publication
(10) Pub. No.: US 2025/0056523 A1
(43) Pub. Date: Feb. 13, 2025

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/928,523

(22) Filed: Oct. 28, 2024

Related U.S. Application Data
(63) Continuation of application No. PCT/JP2023/016513, filed on Apr. 26, 2023.

(30) Foreign Application Priority Data
Apr. 27, 2022 (JP) 2022-073807

(51) Int. Cl. H04W 72/11

(52) U.S. Cl. CPC H04W 72/11

(57) ABSTRACT

A communication control method according to one aspect is a communication control method in a mobile communication system. The communication control method includes the step of extending, at a user equipment, monitoring of a PDSCH or monitoring of a PDCCH for a predetermined period when not having received the PDSCH or the PDCCH from a base station at a Semi-Persistent Scheduling (SPS) periodicity timing or a Discontinuous Reception (DRX) periodicity timing.

### RELATED APPLICATIONS

The present application is a continuation based on PCT Application No. PCT/JP2023/016513, filed on Apr. 26, 2023, which claims the benefit of Japanese Patent Application No. 2022-073807 filed on Apr. 27, 2022. The content of which is incorporated by reference herein in their entirety.

### TECHNICAL FIELD

The present disclosure relates to a communication control method in mobile communication systems.

### BACKGROUND

In specifications of the Third Generation Partnership Project (3GPP) (registered trademark. The same applies below) that is a standardization project for mobile communication systems, extended Reality (XR) has been approved for Release 18. XR is a broad term that includes Virtual Reality (VR), Augmented Reality (AR), and Mixed Reality (MR), and represents an environment obtained by merging a real world and a virtual space. XR represents a mixed environment of a real space and a virtual space generated by a computer technology and wearable devices, and expresses interactions between a human and a machine.

### CITATION LIST

### Non-Patent Literature

Non-Patent Document 1: RP-213587, 3GPP TSG RAN Meeting #94e, “Study on XR Enhancements for NR”, Nokia, Dec. 6-17, 2021.
Non-Patent Document 2: 3GPP TR 38.838 V17.0.0 (2021-12)

### SUMMARY

A communication control method according to one aspect is a communication control method in a mobile communication system. The communication control method includes the step of extending, at a user equipment, monitoring of a PDSCH or monitoring of a PDCCH for a predetermined period when not having received the PDSCH or the PDCCH from a base station at a Semi-Persistent Scheduling (SPS) periodicity timing or a Discontinuous Reception (DRX) periodicity timing.

A communication control method according to one aspect is a communication control method in a mobile communication system. The communication control method includes the step of extending, at a user equipment, transmission of a PUSCH for a predetermined period when not having transmitted the PUSCH to a base station at a Configured Grant (CG) periodicity timing.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack for a user plane according to the first embodiment.

FIG. 5 is a diagram illustrating a configuration example of a protocol stack for a control plane according to the first embodiment.

FIG. 6 is a diagram illustrating an operation example according to the first embodiment.

FIG. 7 is a diagram illustrating an operation example according to a second embodiment.

FIG. 8 is a diagram illustrating an operation example according to a third embodiment.

### DESCRIPTION OF EMBODIMENTS

An aspect of the present disclosure provides a communication control method that can appropriately perform communication using XR.

A mobile communication system according to an embodiment is described with reference to the drawings. In the description of the drawings, the same or similar parts are denoted by the same or similar reference signs.

### First Embodiment

### Configuration of Mobile Communication System

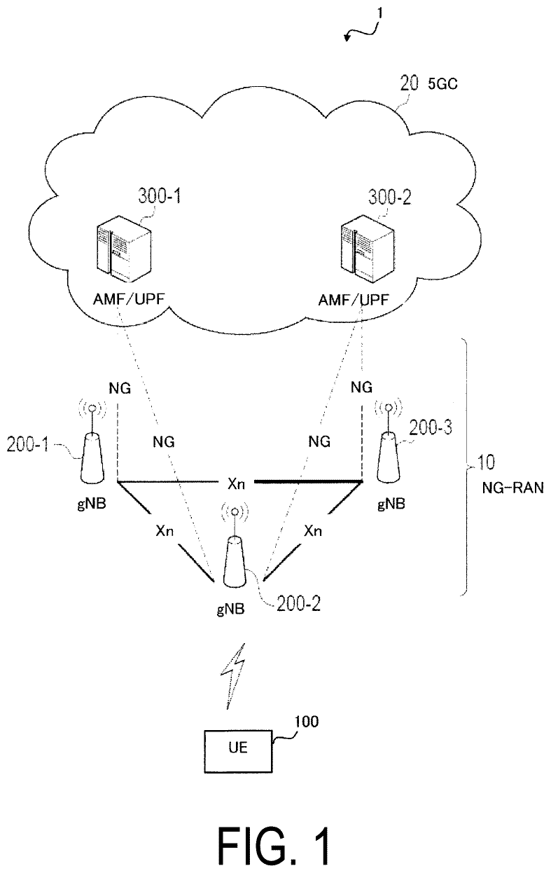

FIG. 1 is a diagram illustrating a configuration of a mobile communication system according to a first embodiment. The mobile communication system 1 complies with the 5th Generation System (5GS) of the 3GPP standard. The description below takes the 5GS as an example, but

Long Term Evolution (LTE) system may be at least partially applied to the mobile communication system. Alternatively, a sixth generation (6G) system may be at least partially applied to the mobile communication system. The mobile communication system 1 includes a User Equipment (UE) 100, a 5G radio access network (Next Generation Radio Access Network (NG-RAN)) 10, and a 5G Core

Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone) or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The UE 100 includes an XR device. The XR device is, for example, a device that can process XR. More specifically, the XR device includes a Head Mount Display (HMD) that can be mounted on a head of a person, an eyeglass-type AR glass (or smart glass), a mobile handset that can be held by a hand, a wristwatch-type device (smartwatch), and a smartphone. These XR devices may be referred to as wearable devices. The HMD includes a display, a lens, a tracking sensor, a camera, a control unit (such as a Central Processing Unit (CPU) or a Graphics Processing Unit (GPU)) that performs processing related to the XR, and a communication function. The AR glass has a function of allowing a video to transmit therethrough. The mobile handset may include various sensors such as tracking sensors. The HMDs, the AR glasses, the wristwatch-type devices, and the mobile handsets have communication functions that support the 5G systems and the like. Hereinafter, the UE 100 will be described assuming that the UE 100 includes such an XR device.

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface, which is an interface between a base station and the core network.

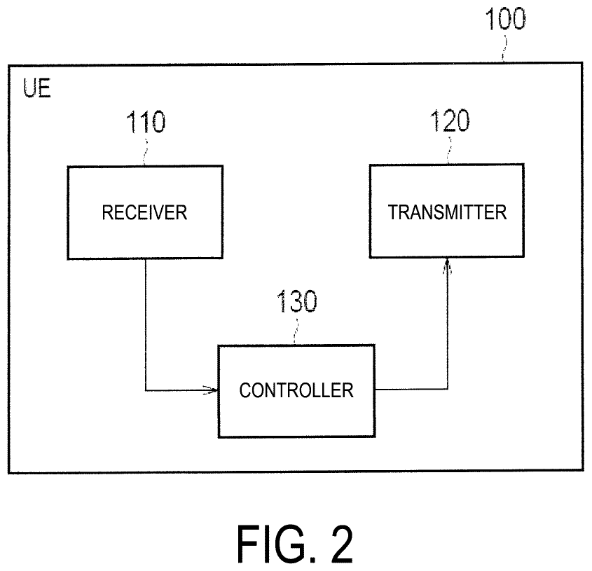

FIG. 2 is a diagram illustrating a configuration of the user equipment (UE) 100 according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that the controller 130 may perform each processing and each operation in the UE 100 in each embodiment to be described below.

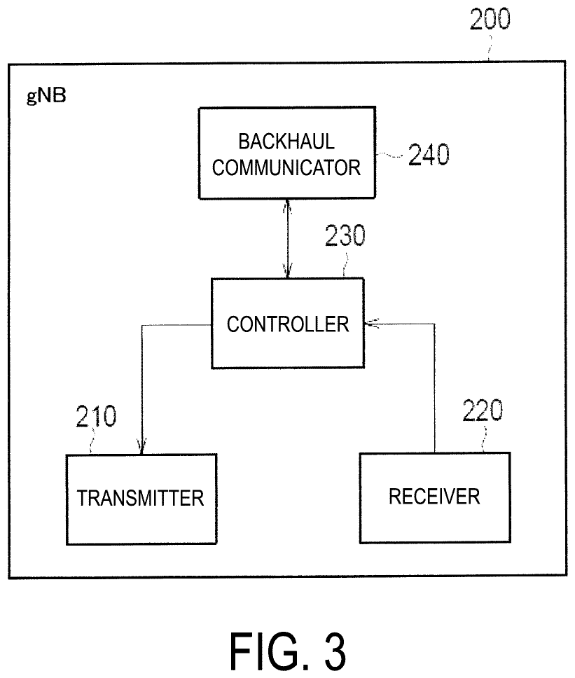

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. Note that the controller 230 may perform all of the processing and operations in the gNB 200 in each embodiment to be described below.

The backhaul communicator 240 is connected to a neighboring base station via an Xn interface, which is an inter-base station interface. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

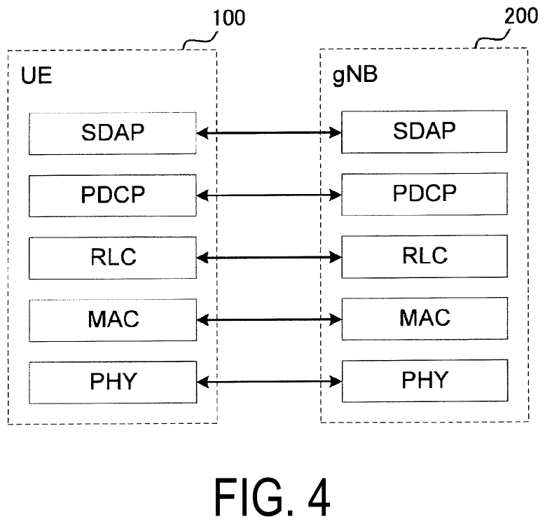

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

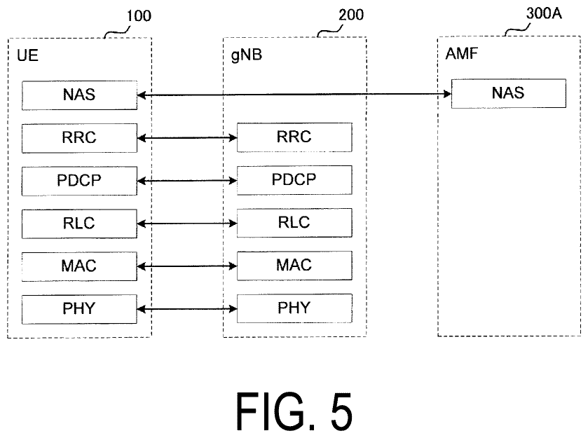

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is positioned upper than the RRC layer, performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as Access Stratum (AS).

### XR

As described above, XR is a broad term that includes, for example, Virtual Reality (VR), Augmented Reality (AR), and Mixed Reality (MR) and represents an environment obtained by merging a real world and a virtual space. XR is also, for example, a generic term for such various types of realities. XR is also, for example, a generic term for a technology that enables perception of something that does not exist in reality by, for example, merging the real world and the virtual space.

According to XR, the UE 100 that is a portable or wearable end-user device assists human-to-machine or human-to-human communication to execute. Such communication enables application of XR to various application fields such as entertainment, healthcare, or education.

In addition to XR, Cloud Gaming (CG) is one of use cases in future mobile systems. Cloud gaming is, for example, a generic term for use cases where most of computation related to a game is offloaded to an edge server or a remote server. According to cloud gaming, the UE 100 transmits information related to pose and/or control. A cloud side performs computation and the like related to video data or the like based on these pieces of information, and provides videos and the like related to the game to the UE 100.

Note that Virtual Reality (VR) refers to creating an environment that is not an original (or a real world), yet whose functional essence is the same as the original by stimulating a user's sense. According to Virtual Reality (VR), a user generally wears an HMD, the user's field of view is replaced with simulated visual elements, and accompanying audios are provided to the user through a headphone. The virtual space is designed to mimic sensory stimulation of a visual sense, an auditory sense, or the like of the real world as naturally as possible. Metaverse that is a virtual space (or service) constructed in a computer or a computer network and is different from the real world may be also included in Virtual Reality (VR).

Augmented Reality (AR) is, for example, a technique of superimposing a virtual space on the real world to display. Augmented Reality (AR) also provides additional information (artificially generated items or content) by superimposing the additional information on an environment of user's reality. The additional information may be also directly perceived without a sensor or the like, or indirectly perceived via a sensor or the like.

Mixed Reality (MR) is a technique that mixes and/or merges, for example, a real world and a virtual space to construct spaces that influence each other in real time. Mixed Reality (MR) is a development form of Augmented Reality (AR) and is constructed with the intention of inserting virtual elements into a physical scene and giving an illusion that the virtual elements are part of an actual scene.

Representative forms of XR are Virtual Reality (VR), Augmented Reality (AR), and Mixed Reality (MR), and XR includes fields for interpolating between these VR, AR, and MR, too.

In many uses cases of XR and Cloud Gaming (CG), a DL direction is characterized by video stream traffic and a UL direction is characterized by traffic that is a combination of pose and/or control and a video stream. The video stream also has a feature that the video stream has a relatively high data rate, and data related to pose and/or control is frequently updated. XR and Cloud Gaming (CG) also have a feature that traffic in the DL direction and traffic in the UL direction are traffic that are strict against delay as compared to other use cases.

### XR Traffic Models

Hereinafter, XR traffic models will be described. The XR traffic models include (1) general traffic models and (2) specific traffic models. First, (1) the general traffic models will be described. (1) The general traffic models include (1.1) traffic models in the DL direction and (1.2) traffic models in the UL direction.

### (1) General Traffic Models

(1.1) Traffic Models in DL direction

The traffic models in the DL direction include a single-stream DL traffic model and a multi stream DL traffic model. The two traffic models can be summarized as follows.

### (1.1.1) Single Stream DL Traffic Model: Series of Video Frames

### (1.1.2) Multi Stream DL Traffic Model:

(1.1.2.1) Option #1: Two Streams of First Stream That Is Intra-Coded (I) Stream and Second Stream That Is Predicted (P) Stream. Option #1 includes a slice-based traffic model (option #1A) and a Group-Of-Picture (GOP)-based traffic model (option #1B).

(1.1.2.1A) Option #1A (slice-based): First Stream Is I Slice (I stream), and Second Stream Is P Slice (P stream). The I slice is, for example, a slice obtained by encoding all macroblocks included in the I slice by intra-frame prediction. The P slice is, for example, a slice obtained by encoding all macroblocks included in the P slice by intra-frame prediction or inter-frame prediction. When a video frame is sliced into N frames, one frame may be the I slice and the remaining (N-1) frames may be the P slices.

(1.1.2.1B) Option #1B (GOP-Based): First Stream Is I Frame (I Stream), and Second Stream Is P Slice (P Stream). The I frame is a frame encoded from the corresponding video frame without using another video frame. The P frame is a frame encoded using a video frame in a temporally forward direction. When a GOP size is K frames, the I frame is transmitted every K frames. The GOP includes the one I frame and the (K-1) P frames.

(1.1.2.2) Option #2: Traffic Model Includes Two Streams of First Stream That Is Video and Second Stream That Is Audio and/or Data.

(1.1.2.3) Option #3: Traffic Model Includes First Stream That Is Field of View (FOV) and Second Stream That Is Omnidirectional View. For example, the FOV is video data of a user's line of sight, and the omnidirectional view is video data of omnidirections that includes the video data of the user's line of sight and whose center is the user.

### (1.2) Traffic Models in UL Direction

The traffic models in the UL direction include pose and/or control stream traffic models. The traffic models are traffic models in which the UE 100 transmits data related to pose and/or control.

### (2) Specific Traffic Models

Specific traffic models include (2.1) a Virtual Reality (VR) traffic model, (2.2) an Augmented Reality (AR) traffic model, and (2.3) a Cloud Gaming (CG) traffic model.

### (2.1) Virtual Reality (VR) Traffic Model

The Virtual Reality (VR) traffic model can be summarized as follows.

### (2.1.1) DL Stream:

Single Stream Model: Identical to Above (1.1.1) “Single Stream DL Traffic Model” (Series of Video Frames)

Multi Stream Model: Identical to Above (1.1.2.2) “Option #2” (First Stream Is Video and Second Stream Is Audio and/or Data)

### (2.1.2) UL Stream: Identical to Above (1.2) “Traffic Model in UL Direction”.

### (2.2) Augmented Reality (AR) Traffic Model

The Augmented Reality (AR) traffic model can be summarized as follows.

### (2.2.1) DL Stream: Identical to Above (2.1.1)

### (2.2.2) UL Stream:

Model #1:1 Stream Model

Model #2:2 Stream Model: First Stream Is Pose and/or Control, and Second Stream Is Collection of Scene (e.g., Continuous Video), Video, Data, and Audio

Model #3A: 3 Stream Model A: First Stream Is Pose and/or Control, Second Stream Is One

Stream of Collection of Stream of Scene and Stream of Video, and Third Stream Is One Stream of Collection of Audio and Data.

Model #3B: 3 Stream Model B: First Stream Is Pose and/or Control, Second Stream Is I Stream of Video, and Third Stream Is P Streams of Video

### (2.3) Cloud Gaming (CG) Traffic Model

The Cloud Gaming (CG) traffic model can be summarized as follows.

### (2.3.1) DL Stream

Single Stream Model: Identical to Above (1.1.1) “Single Stream DL Traffic Model” (Series of Video Frames)

Multi Stream Model: Identical to Above (1.1.2) “Multi Stream DL Traffic Model”

### (2.3.2) UL Stream: Identical to Above (1.2) “Traffic Model in UL Direction”.

### SPS and CG

The 5G system may use a scheduling scheme that is called Semi-Persistent Scheduling (SPS) in the DL direction. SPS is a scheduling scheme where, when, for example, radio resources in the DL direction are allocated by Downlink Control Information (DCI) transmitted using a Physical Downlink. Control Channel (PDCCH), then the UE 100 becomes able to perform communication using the radio resources periodically without using the DCI. Unlike dynamic scheduling of performing scheduling using DCI for each Physical Downlink Shared CHannel (PDSCH), SPS enables semi-static scheduling, so that the number of processing steps in the UE 100 can be reduced. Note that the UE 100 is notified of the periodicity by the gNB 200 through an SPS configuration (SPS-Config) included in an RRC message (e.g., an RRC setup (RRCSetup) message or an RRC reconfiguration (RRCReconfiguration) message). The gNB 200 can also configure a plurality of SPS configurations having different periodicities.

The 5G system may use a scheduling scheme that is called Configured Grant (CG) in the UL direction. CG is a scheduling scheme where, when, for example, radio resources in the UL direction are allocated by DCI transmitted using a PDCCH, then the UE 100 becomes able to perform communication in the UL direction periodically using the radio resources without using the DCI. The UE 100 is notified of the periodicity by the gNB 200 through a CG configuration (ConfiguredGrantConfig) included in an RRC message (e.g., an RRC setup (RRCSetup) message or an RRC reconfiguration (RRCReconfiguration) message). Note that CG includes a type 1 (Type 1) that enables UL transmission without using DCI and a type 2 (Type 2) that performs UL transmission using DCI. In a case of the type 1, the CG configuration directly includes radio resources. The gNB 200 can also configure a plurality of CG configurations having different periodicities.

### Communication Control Method According to First Embodiment

In the XR traffic, jitter is gaining attention.

For example, an average packet arrival time of a video stream is determined based on a frame rate (e.g., frame per second (60 fps)). However, the packet arrival time actually changes depending on encoding delay and transmission delay. Such a change may become jitter and influence the packet arrival time. As described above, the jitter refers to fluctuation of the packet arrival time. In the XR traffic, the jitter is modeled as a random variable added to a periodic packet arrival time.

A case is assumed where the gNB 200 transmits the XR traffic having the jitter using SPS. Since, when the XR traffic target packet arrives from the CN 20 to the gNB 200 earlier than an SPS timing, the gNB 200 may accumulate packets in a buffer or the like, and transmit the packets at the SPS timing, there is no particular problem.

However, when the packets arrive at the gNB 200 at a timing later than the SPS timing, the gNB 200 will wait for transmission of the packets until a next SPS timing. In this case, transmission delay corresponding to one SPS periodicity occurs. On the other hand, the UE 100 cannot receive the packets at the SPS timing, either, and wait for reception of the packets until the next SPS periodicity.

As described above, the XR traffic may cause transmission delay due to the jitter. The transmission delay may influence a User experience (UX) in use cases such as Augmented Reality (AR) or Cloud Gaming (CG). Therefore, the mobile communication system 1 may not be able to appropriately perform communication that uses the XR traffic.

An object of the first embodiment is to appropriately perform communication using the XR traffic.

Therefore, the first embodiment will describe an example where, when the UE 100 cannot receive packets using a PDSCH at the SPS timing, a standby period of the PDSCH is extended.

More specifically, when not having received the PDSCH from the base station (e.g., gNB 200) at the SPS periodicity timing, the user equipment (e.g., UE 100) extends monitoring of the PDSCH for a predetermined period.

Thus, for example, the monitoring period of the PDSCH at the SPS timing is extended, so that the UE 100 can receive packets in the extension period without waiting for one SPS periodicity. Consequently, the transmission delay can be suppressed. Accordingly, the mobile communication system 1 can appropriately perform communication that uses the XR traffic.

Note that the SPS timing is, for example, an SPS periodicity timing. The SPS periodicity timing is, for example, a periodicity timing indicated by an SPS configuration. The UE 100 monitors the PDSCH at the SPS timing. The UE 100 receives the packets transmitted using the PDSCH.

According to 3GPP, an inactivity timer (drx-InactivityTimer) is specified in a Discontinuous Reception (DRX) configuration. The inactivity timer is a timer that, when the UE 100 receives the PDCCH in a DRX on duration, continues monitoring the PDCCH in consideration of reception of the PDCCH. That is, the inactivity timer is a timer that is activated when the UE 100 receives the PDCCH. On the other hand, what is different in the first embodiment from the inactivity timer is that, when not having received the PDSCH, the UE 100 activates the timer.

Note that “reception of a PDSCH” and “reception of packets using a PDSCH” may be used without distinction in the following description. “Transmission of the PDSCH” and “transmission of packets using the PDSCH” may be used without distinction in the following description. “Transmission of a PUSCH” and “transmission of packets using the PUSCH” may be used without distinction in the following description.

### Operation Example of First Embodiment

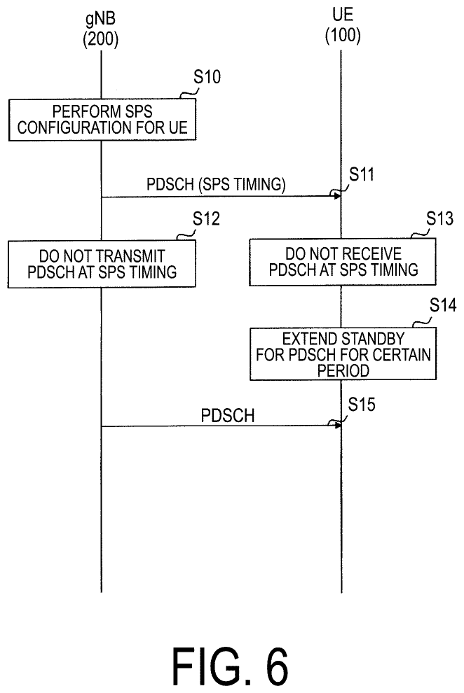

FIG. 6 is a diagram illustrating an operation example according to the first embodiment.

As illustrated in FIG. 6, in step 10, the gNB 200 configures the SPS configuration for the UE 100. The SPS configuration may include configuration information indicating whether to extend monitoring of a PDSCH. The UE 100 can determine based on the configuration information whether to extend monitoring of the PDSCH or to monitor the PDSCH without extending monitoring. The configuration information may include information indicating an extension period of monitoring of the PDSCH. The information indicating the extension period may be represented by a timer value. Note that the gNB 200 may include the SPS configuration including the configuration information in an RRC message, a MAC CE, or the like to transmit to the UE 100.

In step S11, the gNB 200 transmits the PDSCH at an SPS timing. In this case, the UE 100 receives the PDSCH at the SPS timing, and ends monitoring the PDSCH.

In step S12, the gNB 200 does not transmit the PDSCH at the SPS timing. In this case, in step S13, the UE 100 does not receive the PDSCH at the SPS timing.

In step S14, the UE 100 extends monitoring of the PDSCH for a predetermined period after the SPS timing. That is, when not having received the PDSCH from the gNB 200 at an SPS periodicity timing (step S13), the UE 100 extends monitoring of the PDSCH for the predetermined period. Here, the UE 100 determines to extend monitoring of the PDSCH for the predetermined period based on the configuration information (step S10), and extends the monitoring. The predetermined period is, for example, a period indicated by information indicating the extension period included in the configuration information. The UE 100 may count the period by activating a PDSCH standby extension timer. The PDSCH standby extension timer may be activated at a time of end of the SPS timing. Alternatively, the PDSCH standby extension timer may be activated at a time of start of the SPS timing. The UE 100 may continue monitoring the PDSCH while the PDSCH standby extension timer is operating, and stop monitoring the PDSCH at a time of expiration of the PDSCH standby extension timer. Alternatively, the UE 100 may continue monitoring the PDSCH while the PDSCH standby extension timer is operating, and stop the operation of the PDSCH standby extension timer when receiving the PDSCH. The information indicating the extension period included in the configuration information may indicate a period in which the PDSCH standby extension timer is activated.

In step S15, the UE 100 monitors the PDSCH in a predetermined period after the SPS timing, and receives the PDSCH. Note that, when not having received the PDSCH at the SPS timing, the UE 100 extends the period in which the PDSCH is monitored at the SPS timing.

### Variation 1 of First Embodiment

The first embodiment has described the example of SPS. However, the present disclosure is not limited thereto. For example, the present disclosure is also applicable to CG.

That is, the gNB 200 performs for the UE 100 CG configuration including the configuration information indicating whether to extend PUSCH transmission (or radio resources of the PUSCH) for the predetermined period (step S10). The configuration information may include information (e.g., timer value) indicating the extension period of PUSCH transmission (or the radio resources of the PUSCH).

When the UE 100 cannot transmit the PUSCH at the CG timing (or when the UE 100 does not transmit the PUSCH at the CG timing), the UE 100 extends PUSCH transmission (or the radio resources of the PUSCH) for the predetermined period (step S14). The UE 100 determines to extend the PUSCH transmission (or the radio resources of the PUSCH) for the predetermined period based on the configuration information. The predetermined period may be counted by causing the UE 100 to activate the PUSCH extension timer. The PUSCH extension timer may be activated at the time of start of the CG timing. Alternatively, the PUSCH extension timer may be activated at the time of end of the CG timing. The UE 100 may continue PUSCH transmission (or the radio resources of the PUSCH) while the PUSCH extension timer is operating, and stop PUSCH transmission (or the radio resources of the PUSCH) at the time of expiration of the PUSCH extension timer. Alternatively, the UE 100 may continue PUSCH transmission (or the radio resources of the PUSCH) while the PUSCH extension timer is operating, and stop a counting operation of the PUSCH extension timer when transmitting the PUSCH.

As described above, when not having transmitted the PUSCH to the gNB 200 at the CG periodicity timing, the UE 100 extends PUSCH transmission (or the radio resources of the PUSCH) for the predetermined period. Accordingly, also in variation 1, even when the UE 100 cannot transmit the PUSCH at the CG timing, the UE 100 can transmit the PUSCH in the extension period of PUSCH transmission (or the radio resources of the PUSCH) without waiting until a next CG timing. Accordingly, also in variation 1, transmission delay can be suppressed. Accordingly, the mobile communication system 1 can appropriately perform communication that uses the XR traffic.

### Variation 2 of First Embodiment

The first embodiment is also applicable to DRX.

That is, the gNB 200 performs for the UE 100 DRX configuration including configuration information indicating whether to extend monitoring of the PDCCH for a predetermined period in a DRX on duration (step S10). The configuration information may include information (e.g., timer value) indicating the extension period of monitoring of the PDCCH.

When the UE 100 cannot receive the PDCCH in the DRX on duration (On duration) (step S13), the UE 100 extends monitoring of the PDCCH for the predetermined period (step S14). The UE 100 determines to extend monitoring of the PDCCH for the predetermined period based on the configuration information. Similarly to the first embodiment, the PDCCH standby extension timer may be used to count the predetermined period. The operation of the PDCCH standby extension timer may be the same as and/or similar to that in the first embodiment.

As described above, when not having received the PDCCH from the gNB 200 at the DRX periodicity timing (i.e., on duration), the UE 100 extends monitoring of the PDCCH for the predetermined period. Thus, also in variation 2, even when the PDCCH cannot be received in the DRX on duration, the PDCCH can be received in the extension period of PDCCH monitoring without waiting for the next ON interval. Thus, also in variation 2, transmission delay can be suppressed. Accordingly, the mobile communication system 1 can appropriately perform communication that uses the XR traffic.

### Second Embodiment

A second embodiment will be described.

In the first embodiment, an example has been described where the gNB 200 transmits the configuration information to the UE 100, and the UE 100 extends monitoring of the PDSCH when not having received the PDSCH at the SPS timing.

The second embodiment will describe an example where the gNB 200 instructs the UE 100 to extend monitoring of the PDSCH.

More specifically, firstly, a base station (e.g., gNB 200) transmits to a user equipment (e.g., UE 100) a first standby extension notification indicating to extend monitoring of a PDSCH for a predetermined period. Secondly, the user equipment extends monitoring of the PDSCH for a predetermined period in response to reception of the first standby extension notification.

Thus, for example, the gNB 200 notifies (or instructs) the UE 100 of extension of monitoring of the PDSCH at the SPS timing, so that the gNB 200 can take the initiative in controlling extension of monitoring of the PDSCH for the UE 100.

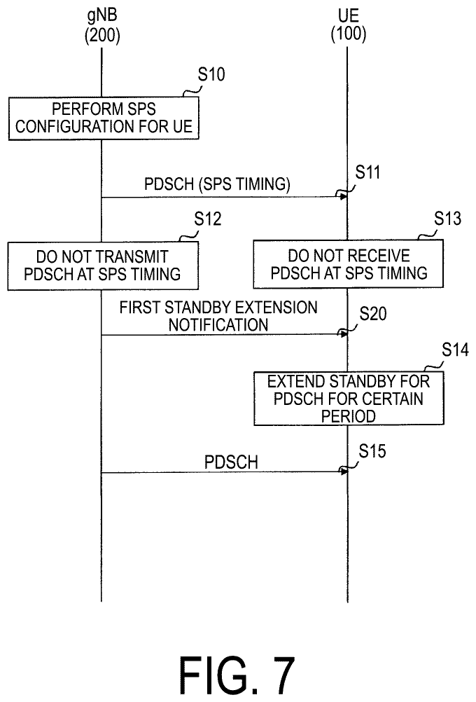

FIG. 7 is a diagram illustrating an operation example according to the second embodiment. Differences from the first embodiment will be mainly described below.

As illustrated in FIG. 7, in step S12, the gNB 200 does not transmit the PDSCH at the SPS timing.

In step S20, the gNB 200 transmits to the UE 100 the first standby extension notification indicating to extend monitoring of the PDSCH for a predetermined period. The gNB 200 may transmit a MAC CE or DCI including the first standby extension notification to the UE 100.

In step S14, the UE 100 extends monitoring of the PDSCH at the SPS timing for the predetermined period in response to reception of the first standby extension notification.

Similarly to variation 1 of the first embodiment, the first standby extension notification may be a notification indicating to extend PUSCH transmission (or radio resources of the PUSCH) at the CG timing for the predetermined period.

Similarly to variation 2 of the first embodiment, the first standby extension notification may be a notification indicating to extend monitoring of the PDCCH in the DRX on duration for the predetermined period.

### Third Embodiment

A third embodiment will be described.

The second embodiment has described the example where the gNB 200 transmits the first standby extension notification to the UE 100. The third embodiment will describe an example where the UE 100 transmits a standby extension notification (referred to as a “second extension standby notification”) to the gNB 200.

More specifically, the user equipment (e.g., UE 100) transmits to the base station (e.g., gNB 200) the second standby extension notification indicating to extend monitoring of the PDSCH for a predetermined period.

Thus, for example, reception of the second standby extension notification becomes a trigger that enables the gNB 200 to transmit the PDSCH.

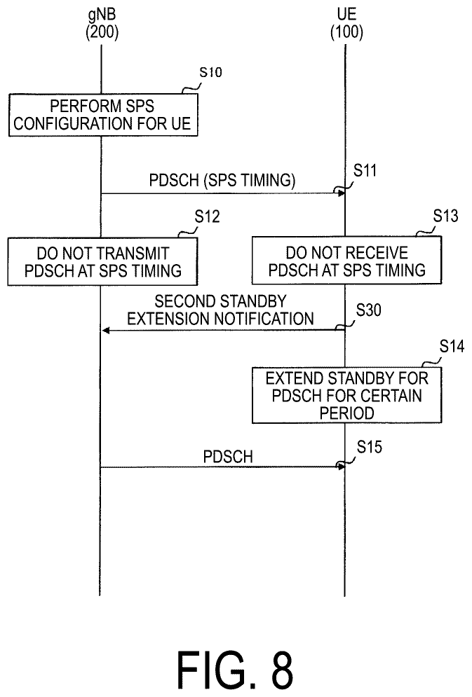

FIG. 8 is a diagram illustrating an operation example according to the third embodiment. Differences from the second embodiment will be mainly described below.

As illustrated in FIG. 8, in step S10, the gNB 200 may configure for the UE 100 transmission of the second standby extension notification. The gNB 200 may transmit to the UE 100 configuration information including information indicating the second standby extension notification.

In step S12, the gNB 200 does not transmit the PDSCH at the SPS timing. In step S13, the UE 100 does not receive the PDSCH at the SPS timing.

In step S30, the UE 100 transmits to the gNB 200 the second standby extension notification indicating to extend monitoring of the PDSCH for a predetermined period. The UE 100 may transmit a MAC CE or DCI including the second standby extension notification to the gNB 200.

In step S14, the UE 100 extends monitoring of the PDSCH at the SPS timing for the predetermined period.

Similarly to variation 1 of the first embodiment, the second standby extension notification may be a notification indicating to extend PUSCH transmission (or radio resources of the PUSCH) at the CG timing for the predetermined period.

Similarly to variation 2 of the first embodiment, the second standby extension notification may be a notification indicating to extend monitoring of the PDCCH in the DRX on duration for the predetermined period.

### OTHER EMBODIMENTS

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM and/or a DVD-ROM.

Circuits for executing processing performed by the UE 100 or the gNB 200 may be integrated, and at least a part of the UE 100 or the gNB 200 may be implemented as a semiconductor integrated circuit (chipset, system on a chip (SoC)).

Embodiments have been described above in detail with reference to the drawings, but specific configurations are not limited to those described above, and various design variation can be made without departing from the gist of the present disclosure. All or some of the embodiments, operations, processes, and steps may be combined without being inconsistent.

The phrases “based on” and “depending on” used in the present disclosure do not mean “based only on” and “only depending on,” unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

### Supplementary Note

In one embodiment, (Supplementary note 1) a communication control method in a mobile communication system can include the step of extending, at a user equipment, monitoring of a PDSCH or monitoring of a PDCCH for a predetermined period when not having received the PDSCH or the PDCCH from a base station at a Semi-Persistent Scheduling (SPS) periodicity timing or a Discontinuous Reception (DRX) periodicity timing.

(Supplementary Note 2) According to the communication control method according to above (Supplementary Note 1) can further include the step of transmitting, at the base station to the user equipment, configuration information indicating whether to extend the monitoring of the PDSCH or the monitoring of the PDCCH for the predetermined period, wherein the extending step can include the step of extending, at the user equipment, the monitoring of the PDSCH or the monitoring of the PDCCH for the predetermined period based on the configuration information.

(Supplementary Note 3) According to the communication control method according to above (Supplementary Note 1) or (Supplementary Note 2) can further include the step of transmitting, at the base station to the user equipment, a first standby extension notification indicating to extend the monitoring of the PDSCH or the monitoring of the PDCCH for the predetermined period, wherein the extending step can include the step of extending, at the user equipment, the monitoring of the PDSCH or the monitoring of the PDCCH for the predetermined period in response to reception of the first standby extension notification.

(Supplementary Note 4) According to the communication control method according to any one of above (Supplementary Note 1) to (Supplementary Note 3) can further include the step of transmitting, at the user equipment to the base station, a second standby extension notification indicating to extend the monitoring of the PDSCH or the monitoring of the PDCCH for the predetermined period.

In one embodiment, (Supplementary Note 5) a communication control method in a mobile communication system can include the step of extending, at a user equipment, transmission of a PUSCH for a predetermined period when not having transmitted the PUSCH to a base station at a Configured Grant (CG) periodicity timing.

(Supplementary Note 6) The communication control method according to above (Supplementary Note 5) can further include the step of transmitting, at the base station to the user equipment, configuration information indicating whether to extend the transmission of the PUSCH for the predetermined period, wherein the extending step can include the step of extending, at the user equipment, the transmission of the PDSCH for the predetermined period based on the configuration information.

(Supplementary Note 7) The communication control method according to above (Supplementary Note 5) or (Supplementary Note 6) can further include the step of transmitting, at the base station to the user equipment, a first standby extension notification indicating to extend the transmission of the PUSCH for the predetermined period, wherein the extending step can include the step of extending, at the user equipment, the transmission of the PUSCH for the predetermined period in accordance with the first standby extension notification.

(Supplementary note 8) The communication control method according to above (Supplementary note 5) to (Supplementary note 7) can further include the step of transmitting, at the user equipment to the base station, a second standby extension notification indicating to extend the transmission of the PUSCH for the predetermined period.

### REFERENCE SIGNS

1: Mobile communication system
20: CN
100: UE
110: Receiver
120: Transmitter
130: Controller
200: gNB
210: Transmitter
220: Receiver
230: Controller
300: AMF

1. A communication control method in a mobile communication system comprising, at a user equipment, extending monitoring of a PDSCH or monitoring of a PDCCH for a predetermined period when not having received the PDSCH or the PDCCH from a network node at a Semi-Persistent Scheduling (SPS) periodicity timing or Discontinuous Reception (DRX) periodicity timing.

2. The communication control method according to claim 1, further comprising transmitting, at the network node to the user equipment, configuration information indicating whether to extend the monitoring of the PDSCH or the monitoring of the PDCCH for the predetermined period,
wherein the extending comprises extending, at the user equipment, the monitoring of the PDSCH or the monitoring of the PDCCH for the predetermined period based on the configuration information.

3. The communication control method according to claim 1, further comprising transmitting, at the network node to the user equipment, a first standby extension notification indicating to extend the monitoring of the PDSCH or the monitoring of the PDCCH for the predetermined period,
wherein the extending comprises extending, at the user equipment, the monitoring of the PDSCH or the monitoring of the PDCCH for the predetermined period in response to reception of the first standby extension notification.

4. The communication control method according to claim 1, further comprising transmitting, at the user equipment to the network node, a second standby extension notification indicating to extend the monitoring of the PDSCH or the monitoring of the PDCCH for the predetermined period.

5. A communication control method in a mobile communication system comprising extending, at a user equipment, transmission of a PUSCH for a predetermined period when not having transmitted the PUSCH to a network node at a Configured Grant (CG) periodicity timing.

6. The communication control method according to claim 5, further comprising transmitting, at the network node, to the user equipment, configuration information indicating whether to extend the transmission of the PUSCH for the predetermined period,
wherein the extending comprises extending, at the user equipment, the transmission of the PDSCH for the predetermined period based on the configuration information.

7. The communication control method according to claim 5, further comprising transmitting, at the network node to the user equipment, a first standby extension notification indicating to extend the transmission of the PUSCH for the predetermined period,
wherein the extending comprises extending, at the user equipment, the transmission of the PUSCH for the predetermined period in accordance with the first standby extension notification.

8. The communication control method according to claim 5, further comprising transmitting, at the user equipment to the network node, a second standby extension notification indicating to extend the transmission of the PUSCH for the predetermined period.

9. A user equipment comprising:
a controller configured to extend monitoring of a PDSCH or monitoring of a PDCCH for a predetermined period when not having received the PDSCH or the PDCCH from a base station at a Semi-Persistent Scheduling (SPS) periodicity timing or Discontinuous Reception (DRX) periodicity timing.
